(19) United States
(12) Patent Application Publication
(10) Pub. No.: US 2013/0238432 A1
(43) Pub. Date: Sep. 12, 2013

(54) AUTOMATIC PROVIDER RECOMMENDATION

(71) Applicants: Fan BAI, Ann Arbor, MI (US); Donald K. Grimm, Utica, MI (US); Massimo Osella, Troy, MI (US); Wende Zhang, Troy, MI (US)

(72) Inventors: Fan BAI, Ann Arbor, MI (US); Donald K. Grimm, Utica, MI (US); Massimo Osella, Troy, MI (US); Wende Zhang, Troy, MI (US)

(73) Assignee: GM GLOBAL TECHNOLOGY OPERATIONS LLC, DETROIT, MI (US)

(21) Appl. No.: 13/412,720

(22) Filed: Mar. 6, 2012

(51) Int. Cl. G06Q 30/02

(52) U.S. Cl. 705/14.52; 705/14.58

(57) ABSTRACT

A method includes receiving a query by a current user for a recommendation regarding a provider of a specified service or commodity in a locality. A profile of the current user is obtained. Tracking data is obtained corresponding to a traceable device of each user of a set of users. A relevant subset of the set of users is selected based on the profile of the current user. The query is responded to by generating the recommendation based on the tracking data that corresponds to the selected relevant subset of the users.

### FIELD OF PRESENT INVENTION

### Background

Tourists, visitors, and other people that are new to a location or unfamiliar with a location are often in need of guidance in locating services and commodities. For example, such guidance may be obtained from maps, guidebooks, local newspapers or magazines, computer applications, or online guides or guide services. Such guidance may be relied on to locate restaurants, shopping, lodging, entertainment (e.g. theaters or night clubs), culture (e.g. museums or zoos), medical services, transportation services (e.g. mass transportation stations or depots, or vehicle service stations), points of interest, or recreational or other services. In addition to indicating a location of the required facility or service, such guidance may include ratings, pricing, or other information or indications that may assist a user such as a tourist in selecting a facility or service among many.

One method of assisting in selecting a facility among many is to rely on feedback that is provided by other people who have used similar facilities. For example, a magazine, or online service may enable a person who used a service or facility to rate the results.

Vehicles may carry or be provided with communication devices or equipment. For example, such communication equipment may include V2X communication equipment or cellular communication equipment (e.g. a cellular or other mobile phone carried in the vehicle). Such communications may enable communication between the vehicle and other vehicles, and between the vehicle and one or more stations or servers. Similarly, an individual person may carry a communications device in the form of a mobile phone, a smart phone, or a portable computer or similar device.

### SUMMARY

A method includes receiving a query by a current user for a recommendation regarding a provider of a specified service or commodity in a locality. A profile of the current user is obtained. Tracking data is obtained corresponding to a traceable device of each user of a set of users. A relevant subset of the set of users is selected based on the profile of the current user. The query is responded to by generating the recommendation based on the tracking data that corresponds to the selected relevant subset of the users.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of a system for automatic provider recommendation, in accordance with an embodiment of the present invention;

FIG. 2 is a schematic block diagram of operation of a system for automatic provider recommendation, in accordance with an embodiment of the present invention;

FIG. 3 schematically shows an example of profile comparison in accordance with an embodiment of the present invention;

FIG. 4 schematically illustrates an example of adaptation of a recommendation based on user feedback, in accordance with an embodiment of the present invention; and

FIG. 5 is a flowchart of a method for automatic provider recommendation, in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. It will however be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that throughout the specification discussions utilizing terms such as “processing,” “computing,” “storing,” “determining,” “evaluating,” “calculating,” “measuring,” “providing,” “transferring,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with an embodiment of the present invention, communication between users, or between a user and a central server or facility, may be utilized to automatically provide advice or a recommendation to a current user. A user may include a person who is a driver or passenger of a vehicle, or a pedestrian or other person carrying a mobile device capable of communicating over a network.

For example, a user may request advice regarding selection of a provider of a particular or particular type of, service or commodity in a particular locality. The user who initiates or generates a request or query for advice or a recommendation is herein referred to as the current user, and a traceable device (e.g. cellular phone, device with Global Positioning System (GPS) capability, or other device whose position may be tracked or traced) that is associated with the current user as the current user device. Such a current user may represent, for example, a tourist, visitor, or other person unfamiliar with that locality, or a person who is unfamiliar with providers of the particular service or commodity in that locality. A provider may represent a vendor of a commodity or a provider of a service. Such providers may include, for example, stores, stands or kiosks, restaurants, service stations or garages, tourist attractions, hotels, taxi stands, medical clinics, or any provider of a service or commodity.

A user may represent an individual who operates, or is a passenger in, one or more vehicles (e.g. using a portable and traceable communications device such as a smart phone), may represent collective users of a single vehicle (e.g. using a communications device that is fixed to or incorporated into the vehicle), or may represent a pedestrian or other person who is not associated with a vehicle (e.g. a passenger of public transportation).

In response to the current user's request or query, advice regarding providers of the particular service or commodity may be generated. The generated advice may include one or more recommendations regarding one or more providers of the requested service or commodity in the particular locality. Generation of the recommendations may be based on analysis of information that is derived from one or more sources. The sources may include past behavior of the current user, past behavior of other users of a system of automatic provider recommendation, feedback by the current user, and various network-derived or online sources. For example, the other users may include subscribers to an automatic provider recommendation system.

The device may run, for example, on a user device or on a remote server or computer that may communicate with the user device via a network. A user device may include a portable or fixed device that is associated with the user, or that is associated with a vehicle. User devices may include, for example, cellular or other mobile telephones, smart phones, GPS devices, or vehicle onboard computers. The network may include any communications network to which a user device may connect so as to communicate with other devices or servers.

Generation of a recommendation may include statistical analysis of the behavior of various users. For example, a profile of a user (either the current user or another user) may be constructed. The profile may summarize or characterize past behavior of the user. For example, a vehicle tracking application may indicate locations at which a user parked a vehicle. The vehicle tracking application may run on, or communicate with, a device that is incorporated into vehicle (e.g. onboard computer, processor, or GPS device). As another example, a device tracking application may run, or communicate with, a portable device (e.g. portable telephone, smart phone, GPS device, or a portable computing device) that is carried by the user. The device tracking application may indicate locations (e.g. buildings or other defined areas) into which the device was carried. The location may be considered to be visited if the tracked device entered the location and remained there for a predetermined period of time (or a vehicle sensor indicates that the vehicle was parked). When a location is visited, the tracking application (or associated application) may search a database or other online source (e.g. a map), to identify any provider of a service or commodity that is located at the location that was visited. In the case of ambiguity with regard to the identification (e.g. several providers located in close proximity), the user may be prompted or queried to indicate which service or commodity provider was in fact visited.

Statistical analysis of the providers that were visited by a user may be incorporated into a profile of that user.

A profile of the current user may indicate the current user's preferences. Such preferences may be derived from analysis of the types or properties of services or commodities that the user had utilized in the past (e.g. in other locations). For example, properties may relate to styles (e.g. type of food served in a restaurant or clothing preferences), prices or price ranges, level of service (e.g. full service or self service), a rating or quality (e.g. for a rated provider such as a restaurant or hotel), or feature values derived from the above properties.

Similarly, a profile of other users (residents or visitors) in a particular locality may indicate preferences of the other users with regard to providers of services or commodities in that locality. A subset of the other users' profiles may be selected as being relevant to the current user (e.g. that their preferences are likely to coincide with those of the current user). For example, another user profile may be selected as relevant if that other user's profile is similar to the profile of the current user. The selected subset of relevant profiles may represent those other users whose preferences or tastes are similar to those of the current user.

The selected subset of relevant other users' profiles may be analyzed (in conjunction with other data) to yield one or more recommendations with regard to providers. For example, two or more recommended providers may be reported to the current user in the form of a ranked list, or as a list in which each listed provider is accompanied by a score, rating, or grade.

The various providers may be scored or ranked based on the selected relevant other users' preferences, as indicated by the tracking data. For example, a provider that is frequented more often by other users may be assumed to be more popular with the selected relevant other users than a provider that is frequented less often. The relative popularity of the provider among the selected relevant other users may be used as at least one input in generating a recommendation.

The other users, or the selected relevant other users, may be divided into subgroups. For example, the other users may include natives or residents of the locality on the one hand, and tourists or other visitors to the locality. Separate relative popularities of providers may be calculated for among natives and for among visitors (or for any other division of the other users into separate subgroups, such as by type of associated vehicle). A score may also be provided based on other information in addition to relative popularity. Such other information may include, e.g., ratings in online guides, a stored database containing information that may be updated periodically or as needed, or other external information. A final ranking or scoring of a recommendation may be based on a weighted combination of scores from various sources (e.g. relative popularity among natives, relative popularity among visitors, and online sources).

For example, analysis of user profiles may be represented as a graphic representation. In an example of such a graphic representation, each provider may be represented by a point in a multidimensional space in which each dimension represents a provider feature or property (e.g. price, star rating, user preferences, or another property). A preference of the current user, based on the current user's profile (and details of the request), may also be represented by a point in the graph. A degree of similarity of a provider to the current user's preference may be based on a multidimensional distance (e.g. calculated via a suitable metric which may be also at least partially based on previous user choices) in the multidimensional space between a provider and the current user's preference (the shorter the distance, the more the provider meets the current user's preference). For example, a recommended provider may be selected from among those providers whose multidimensional distance from the current user's preference is less than a predetermined length.

Feedback from the current user may be utilized to adjust a recommendation. For example, if the current user selects a provider with a lower ranking recommendation, or that is not in the list of recommended providers, future recommendations may be adjusted accordingly. For example, weighting of various scoring or rating sources (e.g. natives, visitors, and online sources) may be adjusted in accordance with the current user's selection. As another example, a metric or scaling for calculating a multidimensional distance between representations in a multidimensional profile space of the current user's preference and a provider may be adjusted to reflect the current user's selection. Thus, a future recommendation may more closely approach the current user's actual preferences.

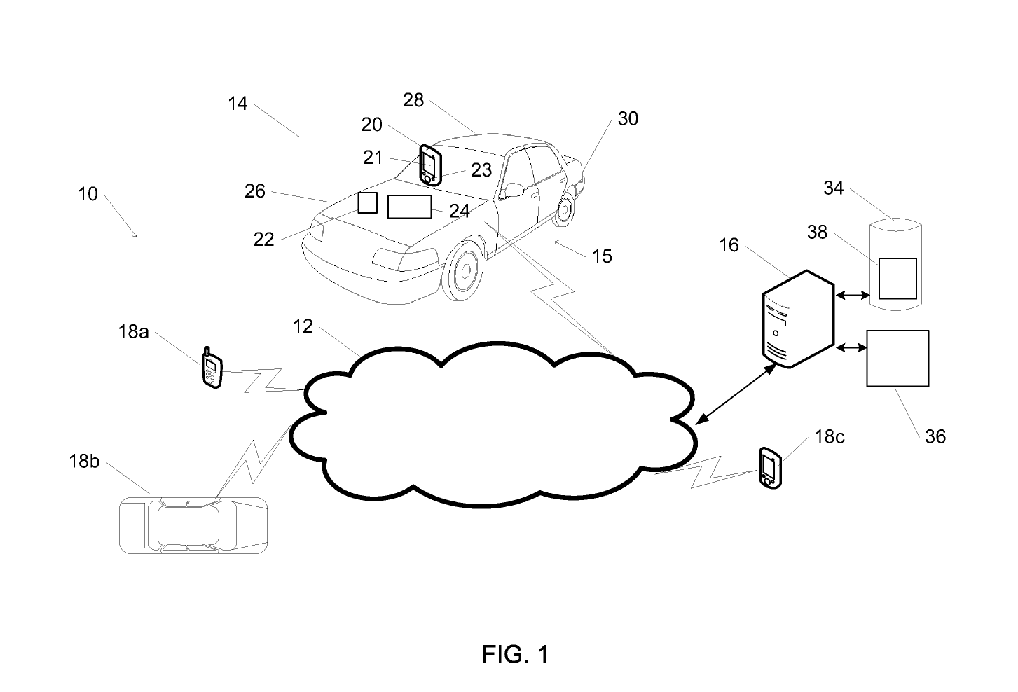

FIG. 1 a schematic diagram of a system for automatic provider recommendation, in accordance with an embodiment of the present invention.

Automatic provider recommendation system 10 includes one or more user devices that may intercommunicate via a network 12. For example, network 12 may represent a wired or wireless network, telephone, or other digital or analog communications system.

A user device of automatic provider recommendation system 10 may be associated with current user 14 or with other users 18a-18c. One or more of the devices associated with current user 14 and other users 18a-18c may be associated with a vehicle, such as vehicle 15. For example, a vehicle 15 may include an onboard computer 22 or an onboard GPS device 24. One or more of the devices associated with current user 14 may include a device 20, such as a portable computer with processing capability, a smart phone, or a mobile telephone. For example, one or more of onboard computer 22, onboard GPS device 24, or device 20 may communicate with other devices (e.g. wirelessly) via network 12. Device 20 may include, or communicate with, output device 21. Output device 21 may include a display, speaker, or other device capable of conveying data or information. Device 20 may include or communicate with an input device 23. Input device 23 may include a keyboard, keypad, pointing device, microphone, or other device by which data or information may be input. Device 20 may include, or may communicate with, a processor.

Similarly, devices of each of other users 18a-18c may communicate with other devices via network 12. For example, one or more of other users 18a-18c may include a mobile phone (as shown for other user 18a), a vehicle and associated devices (as shown for other user 18b), or a portable computer (as shown for other user 18c).

Processor 16 may communicate with devices of current user 14 and other users 18a-18c via network 12. Processor 16 may include one or more processors or processing units that operate in accordance with programmed instructions. Some or all of processing capability of processor 16 may be located in a server or other central computer. In this case, network 12 may represent a communications network of a centralized nature, such as cellular 3G or 4G, e.g. Long Term Evolution (LTE) or Worldwide Interoperability for Microwave Access (WiMax) networks. Some or all of the processing capability of processor 16 may be located in a device that is associated with current user 14 or with one or more of other users 18a-18c. In such a case, network 12 may represent a distributed network architecture such as an ad hoc network, wireless mesh network, or delay-tolerant network. Some or all of the processing capability of processor 16 may be located in a server or other remote computer or device that is configured to communicate with a device of current user 14 via network 12.

Processor 16 may communicate with memory 36. Memory 36 may include one or more volatile or nonvolatile memory devices. Memory 36 may be utilized to store, for example, programmed instructions for operation of processor 16, data or parameters for use by processor 16 during operation, or results of operation of processor 16. Components of memory 36 may be associated with a device of current user 14 or of one or more of other users 18a-18c.

Processor 16 may communicate with data storage device 34. Data storage device 34 may include one or more fixed or removable nonvolatile data storage devices. For example, data storage device 34 may include a computer readable medium for storing program instructions for operation of processor 16. Data storage device 34 may be utilized to store data or parameters for use by processor 16 during operation, or results of operation of processor 16. Components of data storage device 34 may be associated with a device of current user 14 or with a device of one or more of other users 18a-18c.

Data storage device 34 may represent a data storage device that is remote from processor 16. For example, data storage device 34 may represent a storage device of a remote server storing interpret module 22, compare module 24, or risk evaluation module 20 in the form of an installation package or packages that can be downloaded and installed for execution by processor 16, or by a device associated with current user 14 or one or more of other users 18a-18c.

Data storage device 34 may be used to store database 38. For example, database 38 may include tracking data that is received from one or more devices associated with current user 14 or with one or more of other users 18a-18c, results of analysis of tracking data, or provider data. Components of database 38 may be stored on a device that is associated with current user 14 or that is associated with one or more of other users 18a-18c.

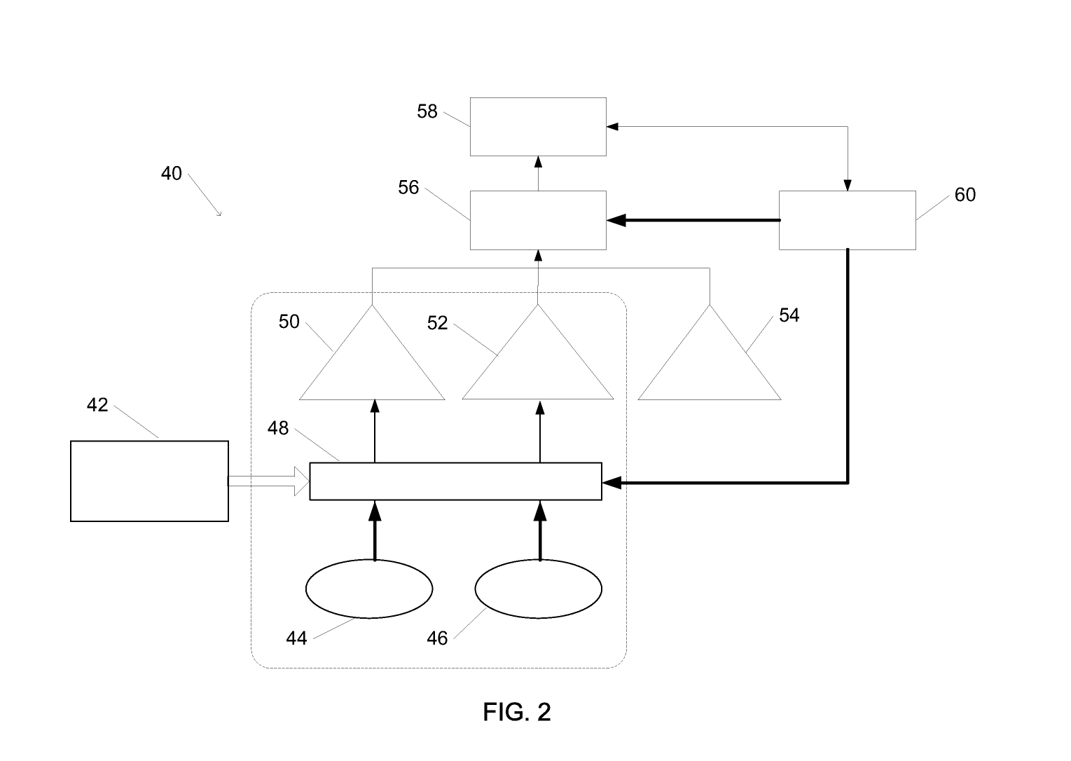

FIG. 2 is a schematic block diagram of operation of a system for automatic provider recommendation, in accordance with an embodiment of the present invention.

Blocks of block diagram 40 may correspond to modules, programs, or applications running on one or more processors. For example, the processors may be associated with devices that are in turn associated with one or more users of a system for automatic provider recommendation.

A current user profile 42 may be derived from tracking a device that is associated with the current user (e.g. the current user representing an individual person or a vehicle). For example, the current user device being tracked may be associated with a particular person (e.g. mobile phone or portable computing device) or with a particular vehicle (e.g. onboard computer or GPS device). An automatic provider recommendation system may track the current user device and record any providers that the user visited. For example, a user may be considered to have visited a provider through the user's navigation destination inputs, and/or when the user device is located within the boundaries of an area or premises that are associated with the provider (e.g. building, courtyard, station, stand, parking lot, or other area that is occupied by, or is associated with, a restaurant, hotel, store, office, transportation provider, service station, or shopping center or mall, theater, museum, or other provider) for at least a predetermined period of time.

As a result of tracking the current user device, a statistical profile of the current user may be constructed. The profile may characterize behavior of the current user. Each provider that the current user frequented may be characterized by one or more characteristics or features. For example, a restaurant may be characterized by a style or taste (e.g. style or type of food that is primarily served by the restaurant), type of service (e.g. fast food, buffet, or waited tables), relative price (e.g. compared to other restaurants), rating (e.g. using a star rating system), or other relevant data. A characterization of a provider such as a restaurant may be obtained from a database of that type of provider (e.g. an online or stored restaurant guide).

A profile may be expressed in terms of a relevant statistical representation for each characteristic. Such a representation may include, for example, a probability distribution function (PDF), or a cumulative distribution function (CDF—relevant for a characteristic, such as a price or rating, that may be expressed in terms of ordered values) that may be derived from a PDF. Information may that is made available to other users of a system for automatic provider recommendation may be limited to such statistical representations or other abstracted representations. Details of movements, actions, or transactions involving the profiled user would not be publicly available. In this manner, privacy of an individual user is protected.

Accuracy of the profile may be enhanced by soliciting user input. For example, when tracking of the current user device indicates that the user has visited a provider, user input may be received or solicited. For example, in the case of a vehicle-mounted device, a driver, operator, or passenger of the vehicle may enter data or information that specifies details of provider that was visited (e.g. which store or restaurant in a shopping mall, or which office in an office building), or of a transaction that occurred (e.g. what was ordered in a restaurant or what was bought in store, price paid, or other information—information regarding the location may be derived from the nature of purchases made). Similarly, a person carrying a portable device may enter similar information. The user may enter data or information in the form of a log, or as answers to a questionnaire. Thus, accuracy of a user profile may be dependent on the degree to which a user is cooperative in entering information.

Devices that are associated with other users (e.g. people or vehicles) of a system for automatic provider recommendation may be similarly tracked. Thus, profiles (e.g. in the form of a collection of statistical representations) of other users may also be created.

Other users may be divided into two or more relevant subgroups for the purpose of tracking and profiling. For example, the other users may be Group A and Group B. Such a division into groups may be based on differences in provider preferences between the different groups. For example, user devices that are associated with visitors to an area may be tracked separately from natives of an area. Thus, one group of Group A and Group B may correspond to visitors to an area, while the other corresponds to natives of the area. In another example of division into groups, each group may correspond to a type or class of vehicle (e.g. one group corresponding to commercial vehicles and the other to private vehicles, or different groups corresponding each to a different type of commercial vehicle, e.g. taxi, delivery van, or truck).

Thus, Group A tracking data 44, and the associated Group A profiles, may be separable (e.g. by marked by a flag or field in a database record, or by storage in separate databases), from Group B tracking data 46, and the associated Group B profiles. For example, division into Group A and Group B may represent separate treatment of visitors and natives. In this case, tracking of an individual user (such as the current user) when that user is found in the user's native geographic area may be treated differently (included in a different group) from tracking of that user when visiting another geographic area.

The current user may query a system for automatic provider recommendation in order to receive a recommendation regarding a provider of a commodity or service. Part (e.g. components of the profile relevant to the query) or all of current user profile 42 may be entered as an input to a relevance filter 48. Group A tracking data 44 and Group B tracking data 46 may be filtered in accordance with current user profile 42.

Relevance filter 48 may select only that data of Group A tracking data 44 and Group B tracking data 46 that correspond to users with similar preferences to the current user. For example, each user profile in Group A tracking data 44 and Group B tracking data 46 may be compared to current user profile 42. Only those profiles in Group A tracking data 44 and Group B tracking data 46 that are sufficiently similar to current user profile 42 may be selected.

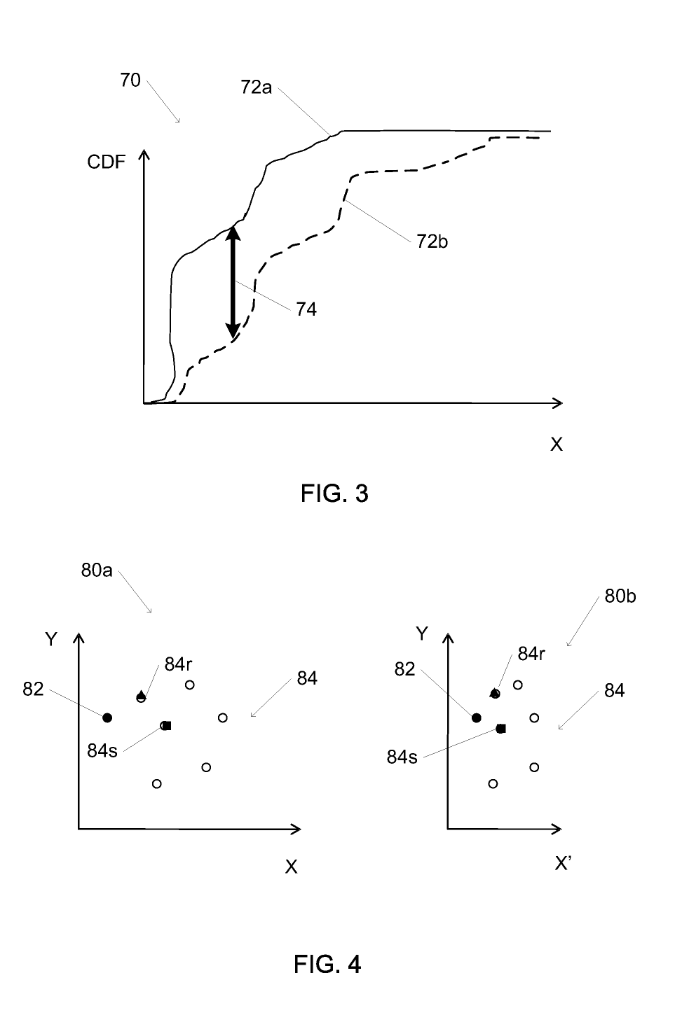

FIG. 3 schematically shows an example of profile comparison in accordance with an embodiment of the present invention. Profile graph 70 includes profile 72a and profile 72b. As shown in FIG. 3, each of profiles 72a and 72b represents a CDF with respect to variable x. Profiles 72a and 72b are profiles of different users (e.g. user a and user b, one of which is the current user). Variable x may represent a characteristic, or composite characteristic, of a provider of a particular type (e.g. a relative price range of a typical meal or item provided by a restaurant, or a star rating of the restaurant). Each of profiles 72a and 72b may be interpretable to represent the fraction of the total number of times that the user visited that type of provider (e.g. restaurant) in which the provider was characterized by a particular value (or range of values) of x (e.g. a particular price range or star rating).

A similarity between a pair of profiles, such as between profile 72a and profile 72b, may be calculated. For example, a Kolmogorov-Smirmov distance 74 may be calculated between a pair of profiles (such as profiles 72a and 72b) in the form of CDF functions, or a Kullback-Leibler distance may be calculated between a pair of profiles in the form of PDF functions, or another profile similarity criterion may be used.

If the two profiles are considered to be similar (e.g. by comparing the calculated similarity to a predetermined threshold), the behavior of other user may be considered relevant to recommending a provider to the current user, and may be passed by relevance filter 48. However, if the two compared profiles are not considered similar, the other user may be excluded from further consideration in recommending a provider to the current user (is blocked by relevance filter 48).

For example, profile 72a may be represented by a CDF function F_{category}(x, a) and profile 72b may be represented by a CDF function F_{category}(x, b). The subscript “category” refers to a type or category of characterization of each visited provider (e.g. price range or star rating for a restaurant). The Kolmogorov-Smirmov D_{kolmogorov-Smirnov} distance 74 between profile 72a and 72b may be calculated as:

$${D}_{Kolmogorov - Smirmov} ( a , b ) = {sup}_{x} \vert {F}_{Category} ( x , a ) - {F}_{Category} ( x , b ) \vert$$

where

$${sup}_{x}$$

represents the supremum over x of the set of distances

F_{Category}(x,a)−F_{Category}(x,b).

The calculated value of D_{Kolmogorov-Smirmov} may be compared to a predetermined (e.g. on the basis of previously indicated preferences of the current user) threshold value. If D_{Kolmogorov-Smirmov} is greater than the threshold value, profiles 72a and 72b may be considered dissimilar. On the other hand, if D_{Kolmogorov-Smirmov} is smaller than (or equal to) the threshold value, profiles 72a and 72b may be considered to be similar. In this case, experience of the profiled other user may be considered relevant to preference of the current user.

Data regarding those other users whose experience is calculated to be relevant to the current user by relevance filter 48 may be analyzed to determine preferences of those selected other users, such as Group A preferences 50 and Group B preferences 52. For example, analysis of data regarding each group (e.g. corresponding to visitors or natives) of other users may indicate a preference of each user that is included in each group. For example, analysis of tracking of users in each group may indicate the number of times that each provider in a particular area was frequented by each user that is included in that group. Differences between different groups may be due, for example, to differing degrees of familiarity with the area (e.g. visitors tending to visit providers that are associated with widely distributed restaurant of retail chains, natives preferring locally known providers) or different preferences (e.g. visitors preferring to visit providers that are considered landmarks, natives preferring lesser known providers).

In addition, preferences may be derived from online knowledge 54. Online knowledge 54 may include, for example, scores or ratings derived from an online guide, or information gathered from individual raters. Online knowledge 54 may also include input data regarding each provider (e.g. with regard to style, pricing, or other relevant information).

A knowledge synthesizer 56 may analyze the data from the various sources. For example, knowledge synthesizer 56 may weight information from each source (e.g. Group A preferences 50, Group B preferences 52, online knowledge 54) differently Similarly, individual inputs from each source may each be assigned a rating. Relative weightings may be at least partially derived from analysis of preferences that were previously indicated by the current user (e.g. one user may prefer to visit a provider that is preferred by tourists, while another prefers the “native experience”). Preferences of individual users or raters within each group may be combined into a single preference distribution for all providers, or to a single number or set of numbers for each provider in the area under consideration (e.g. score, mean rating of each provider, standard deviation, median).

An advisor module 58 may present the current user with one or more recommended providers. For example, several recommended providers may be ranked or scored, or a single recommended provider (or unranked group of recommended providers) may be presented. The recommendations may be displayed visually on a display that is associated with the current user device (e.g. display of mobile phone or portable computer, display of GPS device, dashboard display in vehicle), or may be presented audibly (speaker of mobile phone or portable computer, speaker of GPS device, or speaker system in vehicle).

The current user may either accept the recommendation or reject it (or specify different values in-between, such as neutral), thus generating user feedback 60. For example, system for automatic provider recommendation may include a user interface on a user device. A user, such as the current user, may operate the user interface so as to explicitly indicate selection of a provider. The selected provider may either be one of the recommended providers, or another provider that was not recommended. (For example, upon selecting a provider a trip planning application may provide the user with directions to the selected provider.) As another example, the current user may implicitly accept or reject the recommendation, e.g. by traveling to one of the recommended providers, or to another provider that was not recommended.

The generated user feedback 60 may be used to further adjust relevance filter 48 and knowledge synthesizer 56. For example, if the current user selected a provider that is not the most highly recommended provider or a provider that was not recommended at all, future recommendations may be adapted to the preferences of the current user. Adjustment of future recommendations by such adaptation may yield future recommendations that are more likely to be acceptable to the current user. For example, a weighting that is associated with an input may be adjusted so as to adapt to the current user's indicated preference. Such an adjustment may be graphically represented as an adjustment of a metric or scaling in a multidimensional feature space.

FIG. 4 schematically illustrates an example of adaptation of a recommendation based on user feedback, in accordance with an embodiment of the present invention. Original graph 80a represents a two-dimensional projection of multidimensional feature space prior to adjustment based on user feedback. Each dimension of the multidimensional feature space represents a feature or property of a provider. In particular, a dimension of the multidimensional feature space may represent a preference that is derived from tracking other users, or a subgroup of users.

Axes X and Y of original graph 80a represent two selected properties of a type of provider (e.g. two of a price, star rating, user preference of a restaurant—other properties are ignored for simplicity and clarity). Query point 82 represents the current user's assumed preference with regard to the properties represented by axes X and Y. The location of query point 82 on original graph 80a may be based on a profile of the current user (based on previous behavior), as well as any input by the current user when requesting a recommendation. For example, a user interface of an automatic provider recommendation system may enable a user to input data to further refine the process of automatically generating a recommendation (e g limitations on distance or time of travel from current location, details of service or commodity to be provided).

Providers 84 are located on original graph 80a (e.g. by knowledge synthesizer 56 in FIG. 2) in accordance with values of their corresponding properties as represented by axes X and Y. The shorter the (multidimensional) distance on original graph 80a between a provider 84 and query point 82, the greater the similarity between that provider 84 and what the current user is assumed to be seeking. Thus, recommended provider 84r (only one recommendation is shown for simplicity) may be selected (e.g. by advisor module 58 in FIG. 2) as being the most similar to the sought provider represented by query point 82.

However, the current user may have ignored the recommendation and selected a different provider 84, such as selected provider 84s. A system for automatic recommendation may adapt to the current user's selection in order to, in response to future queries, recommend a provider that is closer to the current user's preference.

For example, one or more axes or metrics may be adjusted in order to modify the calculated multidimensional distances between each graphed provider 84 and query point 82. Adapted graph 80b schematically illustrates such an adaptation of original graph 80a.

In adapted graph 80b, axis X′, representing a provider property, represents a modification (illustrated as shrinking) of axis X of original graph 80a. Thus, as represented in adapted graph 80b, selected provider 84s is nearer to query point 82 than (previously) recommended provider 84r. Thus, when making a recommendation based on adapted graph 80b, selected provider 84s would be recommended instead of (previously) recommended provider 84r.

For example, such an adjustment may be represented as an adjustment of a metric that is used to calculate multidimensional distances in the multidimensional space that is represented schematically by original graph 80a. A metric matrix for calculating multidimensional distances may be required (whether or not adaptation is required) since each axis may represent different types of properties with different scales.

User feedback 60 may be utilized in other ways to adapt future recommendations to the current user's selection. For example, a relevance filter may be adjusted such that those other users that frequented the same provider as was selected by the current user may not be excluded from consideration in the future. Thus, their input may affect future recommendations.

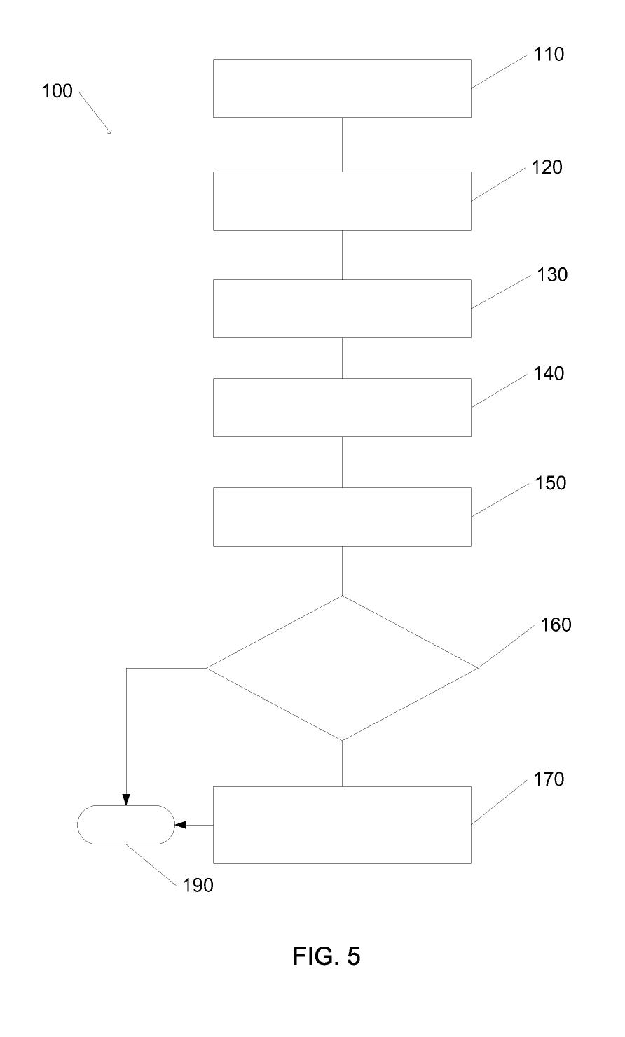

FIG. 5 is a flowchart of a method for automatic provider recommendation, in accordance with an embodiment of the present invention.

It should be understood that the division of the method illustrated by the flowchart into separate operations, each represented by a block of the flowchart, has been selected for convenience and clarity only. Alternative division of the illustrated method into operations is possible with equivalent results. Such alternative division of the method into operations should be considered as included within the scope of embodiments of the present invention.

It should also be understood that, unless indicated otherwise, the illustrated order of operations as represented by blocks of the flowchart has been selected for the sake of convenience and clarity only. The order of execution of illustrated operations may be modified, or operations of the illustrated method may be executed concurrently, with equivalent results. Such reordering of operations illustrated by blocks of the flowchart should be considered as included within the scope of embodiments of the present invention.

Automatic provider recommendation method 100 may be executed by one or more processors that are associated with a system or network for automatic provider recommendation. For example, part of all of automatic provider recommendation method 100 may be executed by a processor that is associated with a user device that is incorporated into, mounted on, or carried by a vehicle, or a portable user device that is associated with a user. Part or all of automatic provider recommendation method 100 may be executed by a server or other remote computer with which the user device may communicate.

Automatic provider recommendation method 100 may be executed when a current user initiates a current query (block 110). For example, the current user may operate an input device of a user device to input a query (e.g. indicate that the user seeks a provider of a service or commodity). In some embodiments of the present invention, an application running on the user device may autonomously, or semi-autonomously, initiate a query. For example, a sensor on a vehicle may indicate that the vehicle requires refueling or other servicing. An application running on a device that is in direct or indirect communication with the sensor may then automatically initiate a query for a recommendation of a provider of vehicle fuel or the other servicing. In another example, an application that communicates with a clock or calendar function may indicate that a mealtime (e.g. as indicated by comparison of the current time of day with predetermined times, e.g. determined as a result of monitoring of previous behavior of the user) has arrived, or that a need for another service (e.g. lodging, laundry, haircut) has arisen. The application may then initiate a query for a recommendation of a provider of the required service.

A profile of the current user's previous behavior may be obtained (block 120). For example, the profile may include a statistical (e.g. PDF or CDF) or other summary of the current user's previous selections of providers of the currently required service or commodity, or of a related service or commodity. The current user profile may be stored on a data storage device or memory device that is associated with a device that is associated with the current user. As another example, the current user profile may be obtained from a remote server, data storage or memory device, or database via a network or other communications channel.

Tracking data of other users may be obtained (block 130). For example, tracking data of other users may include a profile of another user's behavior with regard to the type of provider that is the subject of the current query (or a related type of provider). The other user's profile may be in a form similar to the obtained profile of the current user, as described above. The obtained tracking data may further include a statistical distribution, or other indication (e.g. the provider that was visited the largest number of times) of providers (of the current type or related types) that were frequented by each other user.

From among the obtained tracking data with regard to other users, a relevant subset including the most relevant tracking data may be selected (block 140). Only data regarding those other users whose profiles are sufficiently similar to the profile of the current user may be selected for the subset. For example, similarity between a profile of one of the other users and a profile of the current user may be determined by calculating a characteristic distance, such as a Kolmogorov-Smirmov distance between CDF profiles or a Kullback-Leibler distance between PDF profiles. Inclusion or exclusion from the subset may be determined by comparing the calculated distance with a predetermined threshold. Other determinations of relevance of preferences of one of the other users to the preferences of the current user may be used in selection the subset.

At least partially on the basis of the selected subset of other user data, a recommendation may be generated (block 150). A generated recommendation may include a list of one or more ranked or scored recommended providers. The generated recommendation may be presented, e.g. displayed or audibly communicated. Generation of a recommendation may, in addition, be based on available online or stored data, or other data that is not related to user actions. For the purpose of generating a recommendation, the other users may be divided into one or more subgroups (e.g. visitors or natives; type or purpose of vehicle). Each type of data or information may be weighted such that one type of data (or subgroup of data) may have a greater influence on the generated recommendation than another. For example, a recommendation may be generated on the basis of a calculated multidimensional distance between a representation of each provider in a multidimensional provider property space, and a representation of desired properties of a provider in the same multidimensional provider property space.

A generated recommendation may be accompanied by additional information regarding a recommended provider (e.g. obtained from an online source or stored database) or by directions for traveling to the recommended provider.

The current user may accept or reject the recommendation (block 160). For example, the current user may interact with an automatic provider recommendation program or application via a user interface. The user interface may be operated to explicitly indicate acceptance or rejection of a recommended provider (e.g. by selecting a less recommended provider, or another provider that is not recommended). In another example, the current user may implicitly accept or reject the recommendation by traveling to (or contacting) either a recommended provider or a provider that is not (or less highly) recommended.

If the current user accepts the recommendation, no further action may be necessary (block 190), e.g. until another query is generated (returning to block 110). As another example, the current user may contribute to further refining future recommendations by providing feedback regarding the recommended provider. For example, such feedback may be in the form of an indication of a degree of satisfaction with the provider, or with the service or commodity that was provided by the provider. A more detailed questionnaire may enable further refinement by enabling an indication as to any reasons for dissatisfaction (e.g. whether the current user's preferences differ from those of the other users, or whether information regarding the provider is out of date).

If the current user indicates (explicitly or implicitly) rejection of the recommendation, one or more actions may be taken so as to adapt to the current user's preference (block 190). For example, a filter for selecting a relevant subset of other user data may be adjusted (e.g. a threshold for deciding on relevance between profiles may be adjusted), a recommendation generation algorithm may be adjusted (e.g. weightings of various contributions to a generated recommendation may be adjusted, a metric for determining multidimensional distances in the multidimensional provider property space may be adjusted, a selection of relevant provider properties may be adjusted), or anther adjustment may be made. No further action may then be taken (block 190), e.g. until a new query is entered or generated (returning to block 110). The adjustments made may increase the likelihood that the current user will accept a future recommendation.

Other or different series of operations may be used.

Embodiments of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method comprising:
receiving, by a processor, a query by a current user for a recommendation regarding a provider of a specified service or commodity in a locality;
obtaining a profile of the current user;
obtaining, by a processor, tracking data corresponding to a traceable device of each user of a set of users;
selecting, by a processor, a relevant subset of the set of users based on the profile of the current user, wherein the relevant subset of the set of users represent other users whose preferences are similar to the current user, the users having user profiles similar to the profile of the current user;
responding to the query by generating, by a processor, the recommendation based on the tracking data that corresponds to the selected relevant subset of the users; and
obtaining feedback from the current user with regard to the generated recommendation and adapting the recommendation on the basis of the obtained feedback.

2. The method of claim 1, wherein the current user profile is based on tracking of a traceable device of the current user.

3. The method of claim 2, wherein the current user profile comprises a statistical distribution of visits by the current user to one or more providers of the specified service or commodity with respect to values of a property of the provider.

4. The method of claim 3, wherein the tracking data corresponding to a user of the set of users comprises a user profile, the user profile including a statistical distribution with respect to values of the provider property of visits by the corresponding user to one or more providers of the specified service or commodity.

5. The method of claim 4, wherein the statistical distribution comprises a PDF or a CDF.

6. The method of claim 4, wherein selecting the relevant subset of the users comprises calculating a characteristic distance between the current user profile and the user profile corresponding to a user of the set of users, comparing the calculated characteristic distance to a threshold distance, and selecting those users for which the calculated characteristic distance is less than the threshold distance.

7. The method of claim 6, wherein calculating the characteristic distance comprises using a Kolmogorov-Smirmov distance calculation or a Kullback-Leibler distance calculation or some other statistical measures.

8. (canceled)

9. The method of claim 1, wherein the generated recommendation is represented as a calculated distance between a representation of the query in a multidimensional feature space and a representation of a provider in the same multidimensional space, each dimension of the multidimensional space representing a feature of the provider, and wherein adapting the recommendation comprises adjusting a metric for calculating the distance in the multidimensional space on the basis of the obtained feedback.

10. The method of claim 1, wherein the tracking data that corresponds to the selected relevant subset of the users indicates a relative popularity of a provider in the locality among the selected relevant subset.

11. The method of claim 10, wherein the selected relevant subset of the users is divisible into two or more subgroups and a separate relative popularity is indicated by tracking data that corresponds to each of the subgroups.

12. The method of claim 11, wherein one of the subgroups comprises user who are natives of the locality, and another of the subgroups comprises visitors to the locality.

13. The method of claim 1, wherein the traceable device is associated with a vehicle.

14. A system comprising memory and a processor to:
receive a query by a current user for a recommendation regarding a provider of a specified service or commodity in a locality;
obtain a profile of the current user;
obtain tracking data corresponding to a traceable device of each user of a set of users;
select a relevant subset of the set of users based on the profile of the current user, wherein the relevant subset of the set of users represent other users whose preferences are similar to the current user, the users having user profiles similar to the profile of the current user;
respond to the query by generating the recommendation based on the tracking data that corresponds to the selected relevant subset of the users; and
obtain feedback from the current user with regard to the generated recommendation and adapt the recommendation on the basis of the obtained feedback.

15. The system of claim 14, wherein the traceable device is associated with a vehicle.

16. The system of claim 14, wherein the traceable device is portable.

17. The system of claim 14, wherein the processor is configured to communicate with the traceable device via a centralized network.

18. The system of claim 14, wherein the processor comprises a processing unit that is incorporated in the traceable device, wherein the traceable devices of the users of the set of users are configured to intercommunicate via a distributed network architecture.

19. (canceled)

20. A non-transitory computer readable medium having stored thereon instructions that when executed by a processor will cause the processor to perform the method of:
receiving a query by a current user for a recommendation regarding a provider of a specified service or commodity in a locality;
obtaining a profile of the current user;
obtaining tracking data corresponding to a traceable device of each user of a set of users;
selecting a relevant subset of the set of users based on the profile of the current user, wherein the relevant subset of the set of users represent other users whose preferences are similar to the current user, the others users having user profiles similar to the profile of the current user;
responding to the query by generating the recommendation based on the tracking data that corresponds to the selected relevant subset of the users; and
obtaining feedback from the current user with regard to the generated recommendation and adapting the recommendation on the basis of the obtained feedback.
